(19) United States
(12) Patent Application Publication
(10) Pub. No.: US 2025/0010444 A1
(43) Pub. Date: Jan. 9, 2025

(54) POWERED FASTENER DRIVER

(71) Applicant: MILWAUKEE ELECTRIC TOOL CORPORATION, Brookfield, WI (US)

(72) Inventors: Hunter Kollmann, Milwaukee, WI (US); Troy C. Thorson, Cedarburg, WI (US); Ryan T. Gallagher, Mukwonago, WI (US); David A. Bierdeman, New Berlin, WI (US)

(21) Appl. No.: 18/758,171

(22) Filed: Jun. 28, 2024

Related U.S. Application Data
(60) Provisional application No. 63/642,107, filed on May 3, 2024.
(60) Provisional application No. 63/614,032, filed on Dec. 22, 2023.
(60) Provisional application No. 63/512,216, filed on Jul. 6, 2023.

(51) Int. Cl. B25C 1/06; B23Q 11/00; B25F 5/00

(52) U.S. Cl. CPC B25C 1/06; B23Q 11/005; B25F 5/008

(57) ABSTRACT

A powered fastener driver including a housing defining a cylinder support portion with a cylinder and a motor housing portion. The driver includes a piston and a driver blade. The piston is movable within the cylinder from a top-dead-center (TDC) position to a bottom-dead-center (BDC) position with a blade attached thereto for driving a fastener. The driver includes a lifter for moving the piston and blade, in unison, from the BDC position toward the TDC position. The driver includes a nosepiece from which the fastener is discharged, a motor disposed in the motor housing portion, a fan coupled to the motor to receive torque therefrom, causing the fan to generate an airflow, and a conduit for directing the airflow to at least one of away from the cylinder to clear and/or prevent debris accumulated in the cylinder support portion of the housing, or toward the cylinder for cooling the cylinder.

### CROSS-REFERENCE TO RELATED APPLICATIONS

This application claims priority to U.S. Provisional Patent Application No. 63/642,107, filed May 3, 2024, U.S. Provisional Patent Application No. 63/614,032, filed Dec. 22, 2023, and U.S. Provisional Patent Application No. 63/512,216, filed Jul. 6, 2023, the entire contents of all of which are incorporated by reference herein.

### FIELD OF THE INVENTION

The present invention relates to cordless power tools, and more particularly to powered fastener drivers.

### BACKGROUND OF THE INVENTION

Powered fastener drivers are used to discharge fasteners (e.g., nails or staples) into a workpiece, sometimes generating dust and/or debris that can enter the fastener driver and impede its operation.

### SUMMARY OF THE INVENTION

The present invention provides, in one aspect, a powered fastener driver including a housing defining a cylinder support portion and a motor housing portion and a cylinder within the cylinder support portion. The powered fastener driver includes a piston and a driver blade. The piston is movable within the cylinder from a top-dead-center (TDC) position to a bottom-dead-center (BDC) position. The driver blade is attached to the piston for movement therewith along a driving axis from the TDC position toward the BDC position for driving a fastener into a workpiece. The powered fastener driver includes a lifter operable to move the piston and driver blade, in unison, from the BDC position toward the TDC position. The powered fastener driver includes a nosepiece extending from the housing from which the fastener is discharged, a motor disposed in the motor housing portion, a fan coupled to the motor to receive torque therefrom, causing the fan to rotate and generate an airflow, and a conduit for directing the airflow to at least one of away from the cylinder to clear and/or prevent debris accumulated in the cylinder support portion of the housing, or toward the cylinder for cooling the cylinder.

The present invention provides, in one aspect, a powered fastener driver including a housing defining a cylinder support portion and a motor housing portion and a cylinder within the cylinder support portion. The powered fastener driver includes a piston and a driver blade. The piston is movable within the cylinder from a top-dead-center (TDC) position to a bottom-dead-center (BDC) position. The driver blade is attached to the piston for movement therewith along a driving axis from the TDC position toward the BDC position for driving a fastener into a workpiece. The powered fastener driver includes a lifter operable to move the piston and driver blade, in unison, from the BDC position toward the TDC position. The powered fastener driver includes a nosepiece extending from the housing from which the fastener is discharged, a motor disposed in the motor housing portion. The piston generates an airflow when moving from TDC position to BDC position and the airflow is directed toward the cylinder to cool the cylinder.

The present invention provides, in one aspect, a powered fastener driver including a housing defining a cylinder support portion and a motor housing portion and a cylinder within the cylinder support portion. The powered fastener driver includes a bumper within the cylinder. The powered fastener driver includes a piston movable within the cylinder from a top-dead-center (TDC) position to a bottom-dead-center (BDC) position. The piston impacts the bumper at the BDC position. The powered fastener driver includes a driver blade attached to the piston for movement therewith along a driving axis from the TDC position toward the BDC position for driving a fastener into a workpiece. The powered fastener driver includes a lifter operable to move the piston and driver blade, in unison, from the BDC position toward the TDC position, a nosepiece extending from the housing from which the fastener is discharged, a motor disposed in the motor housing portion, and a thermal conductor disposed between the bumper and the cylinder.

The present invention provides, in one aspect, a powered fastener driver including a housing defining a cylinder support portion and a motor housing portion. The powered fastener driver includes an outer storage cylinder within the cylinder support portion and containing a pressurized gas therein. The outer storage cylinder includes an outer surface. The powered fastener driver includes an inner cylinder in fluid communication with the outer storage cylinder. The powered fastener driver includes a piston movable within the inner cylinder from a top-dead-center (TDC) position to a bottom-dead-center (BDC) position. The powered fastener driver includes a driver blade attached to the piston for movement therewith along a driving axis from the TDC position toward the BDC position for driving a fastener into a workpiece. The powered fastener driver includes a lifter operable to move the piston and driver blade, in unison, from the BDC position toward the TDC position. The powered fastener driver includes a nosepiece extending from the housing from which the fastener is discharged and a motor disposed in the motor housing portion. The outer surface includes a first surface area portion and a second surface area portion. The second surface area portion of the outer surface includes a finish coating visible through an opening in the housing. The first surface area portion of the outer surface is devoid of the finish.

Other features and aspects of the invention will become apparent by consideration of the following detailed description and accompanying drawings.

### BRIEF DESCRIPTION OF THE DRAWINGS

FIG. 1 is an isometric view of a powered fastener driver in accordance with an embodiment of the invention.

FIG. 2 is a cross-sectional view of the powered fastener driver of FIG. 1, taken along section 2-2 in FIG. 1.

FIG. 3 is a cross-sectional view of the powered fastener driver of FIG. 1, taken along section 3-3 in FIG. 1.

FIG. 4 is a cross-sectional view of the powered fastener driver of FIG. 1, taken along section 4-4 in FIG. 1.

FIG. 5 is an isometric view of a first housing portion of the powered fastener driver of FIG. 1.

FIG. 6 is an isometric view of an embodiment of a cylinder assembly for use with a powered fastener driver.

FIG. 7 is a cross-sectional view through section 7-7 of the cylinder assembly of FIG. 6 illustrating a check valve positioned in the passageway for supplementing pressure in the fastener driver.

FIG. 8 is a cross-sectional view of the cylinder assembly of FIG. 6 though section 8-8, showing a pressure relief valve.

FIG. 9A is a top view of an embodiment of a fan and baffle for use in a powered fastener driver.

FIG. 9B is an isometric view of the fan and baffle of FIG. 9A.

FIG. 10 is a side view of an embodiment of a powered fastener driver with the cylinder assembly of FIG. 6, including an auxiliary fan below the cylinder to create a cooling airflow around the cylinder.

FIG. 11 is a side view of an embodiment of a powered fastener driver with the cylinder assembly of FIG. 6, including an auxiliary fan at the rear of the cylinder to induce a cooling airflow around the cylinder.

FIG. 12 is a side view of an embodiment of a powered fastener driver with the cylinder assembly of FIG. 6, including an auxiliary fan driven by the lifting assembly to create a cooling airflow around the cylinder.

FIG. 13 is an isometric view of a powered fastener driver in accordance with another embodiment of the invention.

FIG. 14 is an isometric view of the powered fastener driver of FIG. 13 with portions removed.

FIG. 15 is an end view of an outer storage chamber cylinder of the powered fastener driver of FIG. 13.

FIG. 16 is an isometric view of an embodiment of an outer storage chamber cylinder for use with a powered fastener driver.

FIG. 17 is an end view of the outer storage chamber cylinder of FIG. 16.

FIG. 18 is an isometric view of a frame of the powered fastener driver of FIG. 13.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

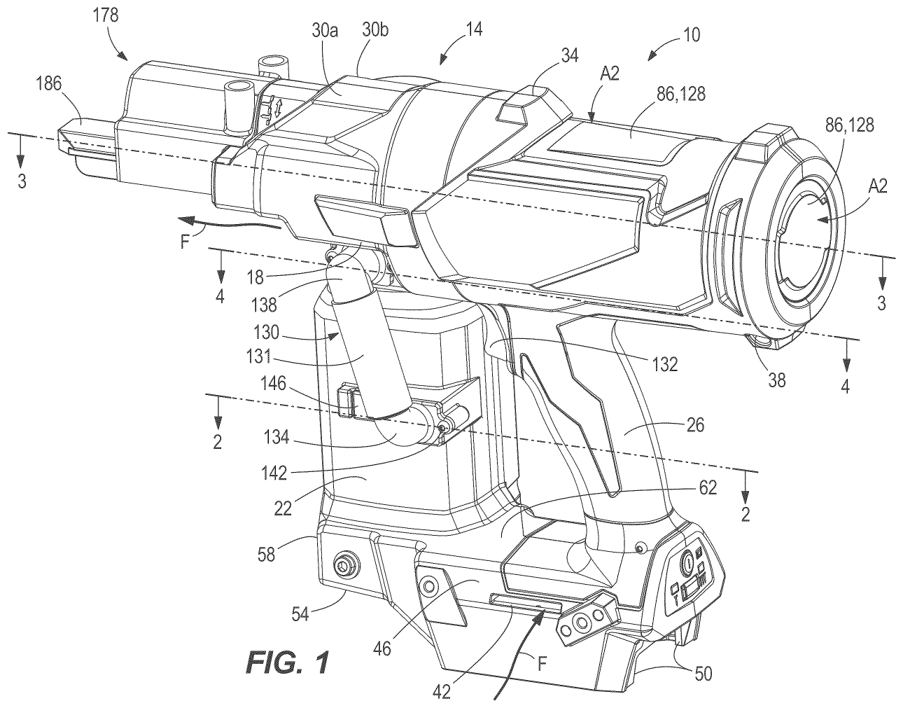

FIG. 1 illustrates a gas spring-powered fastener driver 10 operable to drive fasteners (e.g., nails, tacks, staples, etc.) into a workpiece. The housing 14 includes a cylinder support portion 18, a motor housing portion 22 extending transversely from a bottom end of the cylinder support portion 18, and a handle portion 26 extending away from a middle of the cylinder support portion 18. In the illustrated embodiment, the cylinder support portion 18, the motor housing portion 22, and the handle portion 26 are defined by cooperating first and second clamshell halves 30a, 30b (i.e., first and second housing portions).

The first and second clamshell halves 30a, 30b are coupled together at a seam 34 with fasteners 38. The first clamshell half 30a includes an air inlet opening 42 on a battery receptacle portion 46 of the housing 14. The inlet opening 42 includes a filter (not shown) such that air entering the fastener driver 10 is free of dust debris. In other words, the air entering the fastener driver 10 is filtered air. The battery receptacle portion 46 extends between the motor housing portion 22 and the handle portion 26. The battery receptacle portion 46 includes a battery receptacle 50 configure to receive a battery pack (not shown). The second clamshell half 30b includes an air inlet (not shown) on the battery receptacle portion 46. The air inlet opening 42 is formed in the shape of a slot and is in communication with the motor housing 22 via the battery receptacle portion 46.

The battery receptacle portion 46 of the housing 14 supports a printed circuit board assembly (PCBA, not shown) and permits air from an outer environment into the housing 14 via the inlet opening 42. The inlet opening 42 is positioned on the battery receptacle portion 46 such that air entering the battery receptacle portion 46 flows past the PCBA. The PCBA may include a plurality of semi-conductor switching elements (e.g., MOSFETs, IGBTs, or the like) which may increase a temperature of the PCBA. The position of the inlet opening 42 is selected such that the inflow of air passes the PCBA to decrease the temperature of the PCBA (i.e., to cool the PCBA). In other embodiments, the inlet opening 42 may be located on a bottom 54 and/or a sidewall 58 of the motor housing 22. In yet other embodiments, the inlet opening 42 may be located on a top 62 of the battery receptacle portion 46. In yet other embodiments, the inlet opening 42 may include a plurality of inlets on each clamshell half 30a, 30b.

The PCBA is supplied with electrical current by the battery pack when attached to the battery receptacle 50. The battery pack may be an 18-volt rechargeable power tool battery pack. The battery pack may include multiple battery cells having, for example, a lithium (Li), lithium-ion (Li-ion), or other lithium-based chemistry. For example, the battery cells may have a chemistry of lithium-cobalt (Li-Co), lithium-manganese (Li-Mn) spinel, or Li-Mn nickel. In such embodiments, each battery cell may have a nominal voltage of about, for example, 3.6V, 4.0V, or 4.2V. In other embodiments, the battery cells may have a nickel-cadmium, nickel-metal hydride, or lead acid battery chemistry. In further embodiments, the battery pack may include fewer or more battery cells, and/or the battery cells may have a different nominal voltage. In yet another embodiment, the battery pack may be a dedicated battery housed (partially or entirely) within the fastener driver 10. The battery pack may also be configured for use with other cordless power tools, such as drills, screwdrivers, grinders, wrenches, and saws.

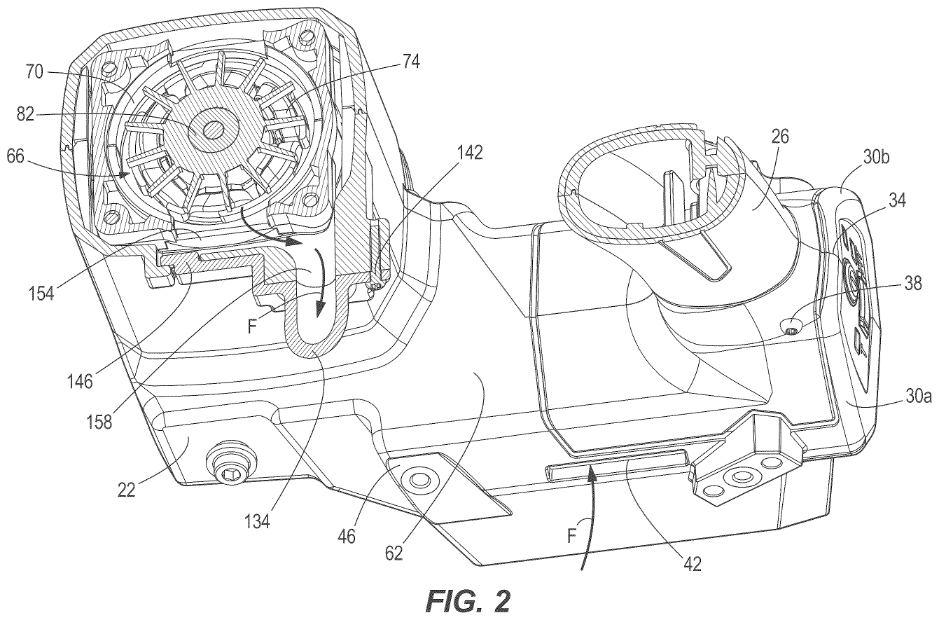

FIG. 2 illustrates the fastener driver 10 including a motor 66 supported in the motor housing 22 via an intermediate motor casing 70. The motor casing 70 is cylindrically shaped and is disposed between the motor 66 and the motor housing 22. The motor 66 includes a stator 74, a rotor (not shown), and a drive shaft (not shown) coupled to the rotor. The fastener driver 10 includes a fan 82 positioned in the motor housing portion 22 that is rotated by the drive shaft. The fan 82 in fluid communication with the air inlet opening 42. The filter (not shown) is upstream relative to the fan 82.

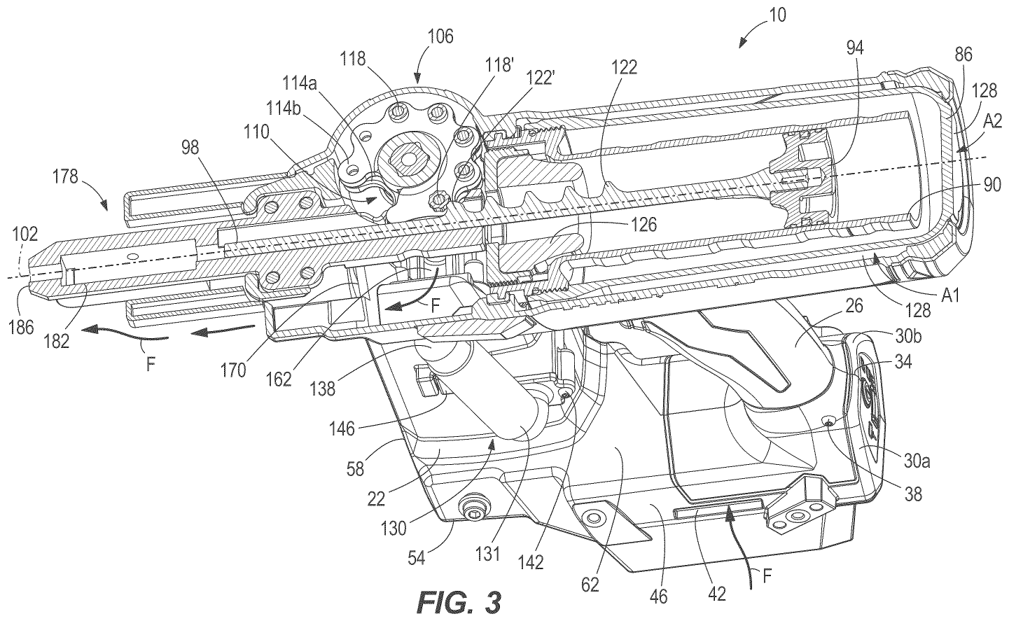

FIG. 3 illustrates a gas spring power mechanism of the fastener driver 10. The first and second housing portions 30a, 30b additionally support an outer storage chamber cylinder 86 (i.e., an outer storage cylinder) within the cylinder support portion 18. The fastener driver 10 includes an inner cylinder 90 within the outer storage chamber cylinder 86. In the illustrated embodiment, each of the cylinders 86, 90 are made of Aluminum. The inner cylinder 90 supports a movable piston 94 positioned within the cylinder 90. The fastener driver 10 further includes a driver blade 98 that is attached to the piston 94 and moveable therewith. The fastener driver 10 does not require an external source of air pressure, but rather the outer storage chamber cylinder 86 includes pressurized gas in fluid communication with the cylinder 90. In the illustrated embodiment, the cylinder 90 and moveable piston 94 are positioned within the storage chamber cylinder 86. The fastener driver 10 further includes a fill valve (not shown) coupled to the storage chamber cylinder 86. When connected with a source of compressed gas, the fill valve permits the storage chamber cylinder 86 to be refilled with compressed gas if any prior leakage has occurred. The fill valve may be configured as a Schrader valve, for example.

The cylinder 90 and the driver blade 98 define a driving axis 102. During a driving cycle, the driver blade 98 and piston 94 are moveable in unison between a top-dead-center (TDC) position (FIG. 3) and a driven or bottom-dead-center (BDC) position. The fastener driver 10 further includes a lifting assembly 106, which has a lifter 110 that is rotated by the motor 66 and that moves the driver blade 98 from the driven position toward the TDC position. A transmission (not shown) provides torque to the lifter 110 from the motor 66. The transmission may be a planetary transmission with a single-stage or a multi-stage planetary transmission including any number of planetary gear stages. The lifter 110 is formed by two plates 114a, 114b and includes multiple drive members 118 extending between the plates 114a, 114b. The drive members 118 are sequentially engageable with the driver blade 98 to raise the driver blade 98 from the driven position toward the TDC position.

In operation, the lifting assembly 106 drives the piston 94 and the driver blade 98 toward the TDC position by energizing the motor 66. As the piston 94 and the driver blade 98 are driven toward the TDC position, the gas above the piston 94 and the gas within the storage chamber cylinder 86 is compressed. Prior to reaching the TDC position, the motor 66 is deactivated and the piston 94 and the driver blade 98 are held in a ready position, which is located between the TDC position and the BDC position, until being released by user activation of a trigger 132 (FIG. 1). When released, the compressed gas above the piston 94 and within the storage chamber cylinder 86 drives the piston 94 and the driver blade 98 to the driven position, thereby driving a fastener into the workpiece. The fastener driver 10 therefore operates on a gas spring principle utilizing the lifting assembly 106 and the piston 94 to further compress the gas within the cylinder 90 and the storage chamber cylinder 86. Further detail regarding the structure and operation of the fastener driver 10 is provided below.

Prior to initiation a firing cycle, the driver blade 98 is held in the ready position with the piston 94 near top dead center within the cylinder 90. More specifically, the first drive member 118′ on the lifter 110 is engaged with a lower-most tooth 122′ of axially spaced lifting teeth 122 on the driver blade 98. At about the same time that the trigger 132 is pulled to initiate a firing cycle, the motor 66 is activated to rotate the lifter 110 in a counter-clockwise direction from the frame of reference of FIG. 3, thereby displacing the driver blade 98 upward past the ready position a slight amount before the lower-most tooth 122′ on the driver blade 98 slips off the first drive member 118′ (at the TDC position of the driver blade 98). Thereafter, the piston 94 and the driver blade 98 are thrust downward toward the driven position by the expanding gas in the cylinder 90 and storage chamber cylinder 86. As the driver blade 98 is displaced toward the driven position, the motor 66 remains activated to continue counter-clockwise rotation of the lifter 110.

Upon a fastener being driven into a workpiece, the piston 94 impacts a bumper 126 to quickly decelerate the piston 94 and the driver blade 98, eventually stopping the piston 94 in the driven or BDC position. In the illustrated embodiment, the bumper 126 is made of rubber. Shortly after the driver blade 98 reaches the driven position, a first of the drive members 118 on the lifter 110 engages the uppermost lifting tooth 122 on the driver blade 98 and continued counter-clockwise rotation of the lifter 110 raises the driver blade 98 and the piston 94 toward the ready position.

With Reference to FIGS. 1 and 3, the outer storage chamber cylinder 86 includes an outer surface 128. The outer surface 128 includes a first surface area portion A1 and a second surface area portion A2. The first surface area portion A1 is best illustrated in FIG. 3 and is enclosed by the first and second clamshell halves 30a, 30b. In other words, the first surface area portion A1 is hidden from the user because the first and second clamshell halves 30a, 30b cover the first surface area portion A1. The first surface area portion A1 accounts between 70% and 100% of a total surface area of the outer storage chamber cylinder 86. The second surface area portion A2 is best illustrated in FIG. 1 and is not enclosed by the first and second clamshell halves 30a, 30b. In other words, the second surface area portion A2 is visible by the user because the first and second clamshell halves 30a, 30b do not cover the second surface area portion A2. Specifically, there is an opening 129 in the first and second clamshell halves 30a, 30b. The second surface area portion A2 accounts between 0% and 30% of the total surface area of the outer storage chamber cylinder 86. In some embodiments of the fastener driver 10, the second surface area portion A2 includes a finish coating (e.g., a powdered coating, liquid paint, anodizing, etc.) to enhance the visual appearance of the exposed second surface area portion A2, whereas the first surface area portion A1 is without such a finish coating (e.g., devoid of the finish).

Applying a finish coating to one or more of the first and second surface area portions A1, A2 can influence the thermal characteristics (e.g., thermal conductivity, thermal convection) of the outer storage chamber cylinder 86. In the illustrated embodiment, the first surface area portion A1 is without a finish coating; therefore, the raw Aluminum material (e.g., bare Aluminum) of the outer storage chamber cylinder 86 is visible (behind the clamshell halves 30a, 30b). In contrast, with the added finish coating (e.g., a powder coating) applied to the second surface area portion A2, the overall thermal conductivity of the outer storage chamber cylinder 86 is reduced because the finish coating itself can behave as an insulator and reduce heat dissipation from the outer storage chamber cylinder 86. Therefore, it can be desirable to minimize the amount of surface area of the outer storage chamber cylinder 86 that has a finish coating, such as in the illustrated embodiment of the fastener driver 10 in which only the visible portion A2 of the cylinder 86 has a finish coating applied to enhance its visual appearance.

In the illustrated embodiment, the difference in conductivity of the outer storage chamber cylinder 86 influences a heat transfer rate Q of the bumper 126. In the illustrated embodiment, the bumper 126 is coupled to the inner cylinder 90, which is coupled to the outer storage chamber cylinder 86. During operation, the repeated impacts between the piston 94 and the bumper 126 increases the temperature of the bumper 126. Accordingly, heat is transferred from the bumper 126 to the inner cylinder 90 and from the inner cylinder 90 to the outer storage chamber cylinder 86. As such, the increased capability of the outer storage chamber cylinder 86 to dissipate heat to the ambient environment results in the bumper 126 transferring more heat to the inner cylinder and the outer storage chamber cylinder 86, resulting in a decreased temperature of the bumper 126. The heat transfer rate of the bumper Q_{bumper} can be modeled using the convection heat transfer equation which states that the heat transfer rate of the bumper Q_{bumper} is equivalent to the product of the convection heat-transfer coefficient h, the exposed surface area A, and the temperature difference ΔT (i.e., Q_{bumper}=hAΔT). The temperature difference ΔT is the difference from the high temperature T1 and the low temperature T2.

As shown in the table below, a test was completed on an outer storage chamber cylinder 86 having an outer surface finish of raw Aluminum and another storage chamber cylinder 86 having an outer surface finish entirely covered in a powdered coating. In the test, the tool was dry-fired every second for 100 consecutive seconds. The time column in the table below represents the duration since the dry-fire test ended. The temperature column represents a temperature reading of the bumper 126. As shown in the last row of the column, the heat transfer rate of the bumper Q_{bumper} of the outer storage chamber cylinder 86 with the raw Aluminum finish is approximately 5.8% greater than the heat transfer rate of the bumper Q_{bumper} of the outer storage chamber cylinder 86 with the power coating finish. As a result, the temperature of the bumper 126 of the outer storage chamber cylinder 86 with the raw Aluminum finish was reduced further than the outer storage chamber cylinder 86 with the powered coating finish as evidenced by the temperature difference ΔT being larger for the raw Aluminum sample (−44.4 degrees C.) versus the powder coated sample (−42 degrees C.).

| | Raw Aluminum Material | | Powdered Coating | |
|---|---|---|---|---|
| | Time | Temperature | Time | Temperature |
| | (s) | (C.) | (s) | (C.) |
| T1 | 101.9 | 86.6 | 130 | 91.4 |
| T2 | 596.4 | 42.2 | 600.4 | 49.4 |
| ΔT | 494.5 | −44.4 | 470.4 | −42 |
| Q_{bumper} | −198.3 | | −187.5 | |
| % change in | 5.8% | | | |
| Q_{bumper} | | | | |

As fasteners are driven out of the fastener driver 10 and into the workpiece, dust and debris can be ejected from the workpiece and may enter the housing 14 of the fastener driver 10. As explained in further detail below, the fastener driver 10 includes a conduit 130 (FIG. 1) through which an airflow F is directed to expel dust and debris from the housing 14 or, in some embodiments, prevent dust and debris from entering the housing 14 fastener driver 10.

With continued reference to FIG. 1, in some embodiments, the conduit 130 is supported on the exterior of the housing 14. The conduit 130 includes tubing 131 that may be made from a polymer, metal, or another suitable material to contain the airflow F. In some embodiments, the conduit 130 may include fittings 134, 138 at opposite ends of the tubing 131. The fittings 134, 138 are secured to the motor housing portion 22 and the cylinder support portion 18, respectively, by fasteners 142. In some embodiments, the fittings 134, 138 may include a flange 146 through which the fasteners 142 extend.

As the drive shaft rotates, the fan 82 induces an airflow into the inlet opening 42 from the outside environment as illustrated with the arrow F in FIG. 1, due to the fluid connection between the battery receptacle portion 46 and the motor housing portion 22. In some embodiments, the airflow F is filtered when entering the air inlet opening 42. The airflow F is induced through the battery receptacle portion 46 and into the motor housing portion 22. The airflow F then flows through the motor 66 and toward the fan 82. The airflow F cools the motor 66 as it travels toward the fan 82. The airflow F is exhausted from the motor housing 22 and through an opening 154 in the motor casing 70, into a fan exhaust passage 158 (i.e., an inlet) that is integrated into the motor housing 22. From the fan exhaust passage 158, the airflow F flows into the conduit 130.

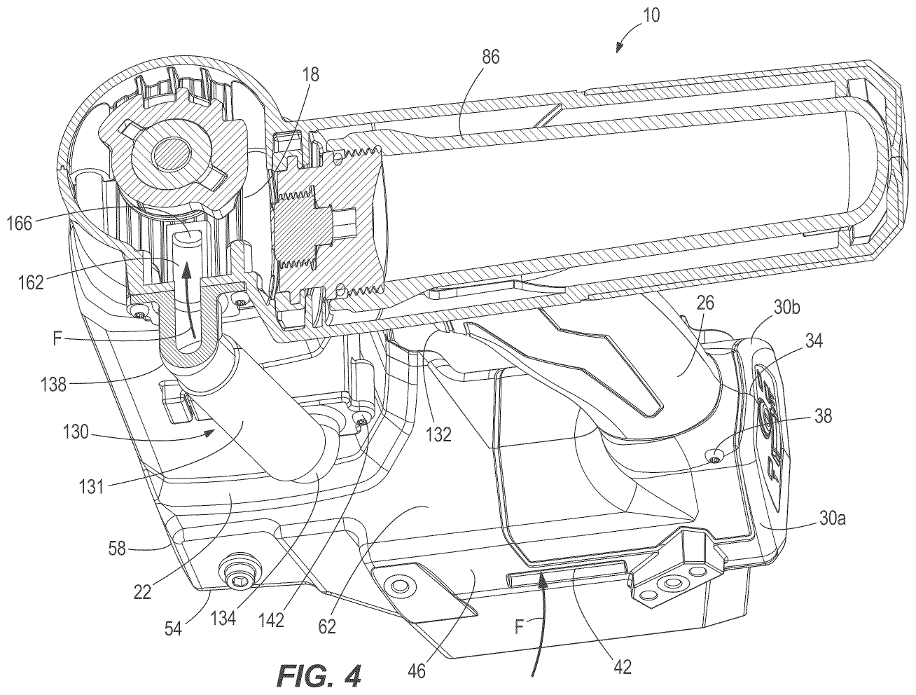

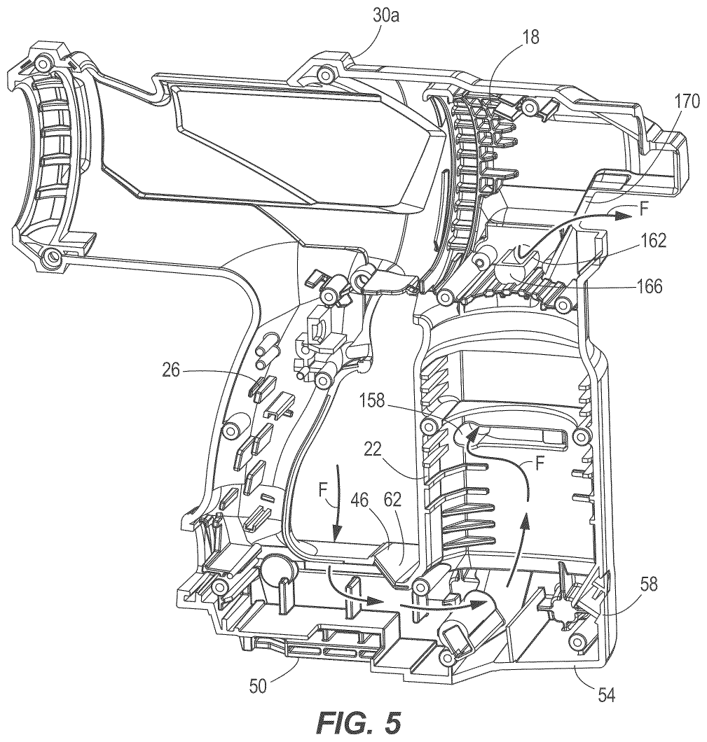

FIG. 4 illustrates the cylinder support fitting 138 coupled to the cylinder support portion 18. The airflow F is directed though the cylinder support fitting 138, the tubing 131, and into an outlet passage 162 (i.e., an outlet). The outlet passage 162 is integrally formed in the first clamshell half 30a. The outlet passage 162 is formed in the shape of a cylinder to match the inner diameter of the cylinder support fitting 138. In other embodiments, the outlet passage 162 may be formed in a different shape from the cylinder support fitting 138 or include a different diameter (e.g., a tapered bore). The cylinder support portion 18 includes a baffle 166 (FIG. 5) integrally formed in the first clamshell half 30a at an end of the outlet passage 162. The baffle 166 redirects the airflow F toward an outlet opening 170 in the first clamshell half 30a through which a nosepiece assembly 178 extends (see also FIG. 3). In other embodiments, the baffle 166 may include angled portions to direct the airflow F toward other locations within the housing 14.

In other embodiments, the housing 14 may support and/or define the conduit 130 within the interior of the housing 14. In such an embodiment, the conduit 130 may be integrated with the first clamshell half 30a and/or the second clamshell half 30b. In other embodiments, the fan exhaust passage 158 and the outlet passage 162 may be formed in the second clamshell half 30b, with the conduit 130 located on the other side of the housing 14 as shown in FIG. 1.

As the airflow F is discharged from the outlet opening 170, dust and debris that may have previously entered the housing 14 is expelled therefrom. Also, while the fan 82 is rotating to create the airflow F, the discharged airflow F from the outlet opening 170 prevents dust and debris from entering the housing 14 through the outlet opening 170 (FIG. 3). Additionally, the nosepiece assembly 178 may be susceptible to dust and debris. The nosepiece assembly 178 includes an opening 182 to receive fasteners from a magazine (not shown). The magazine is oriented such that fasteners are biased toward the opening 182 of the nosepiece assembly 178. The airflow F is directed out of the housing 14 such that airflow F is directed around the opening 182 and the magazine. The airflow F ensures that dust and debris are prevented from entering the opening 182 and the magazine. The airflow F may be directed toward an end 186 of the nosepiece assembly 178 such that dust and debris around the workpiece is cleared prior to driving the fastener. As described above, the airflow F is created whenever the motor 66 is activated because the fan 82 is coupled to drive shaft of the motor 66. Therefore, the fan 82 is rotated by the motor 66 when the driver blade 98 is being driven toward the driven position and returned toward the TDC position. In other embodiments, the motor 66 may be operable to drive the fan 82 without driving the lifting assembly 106.

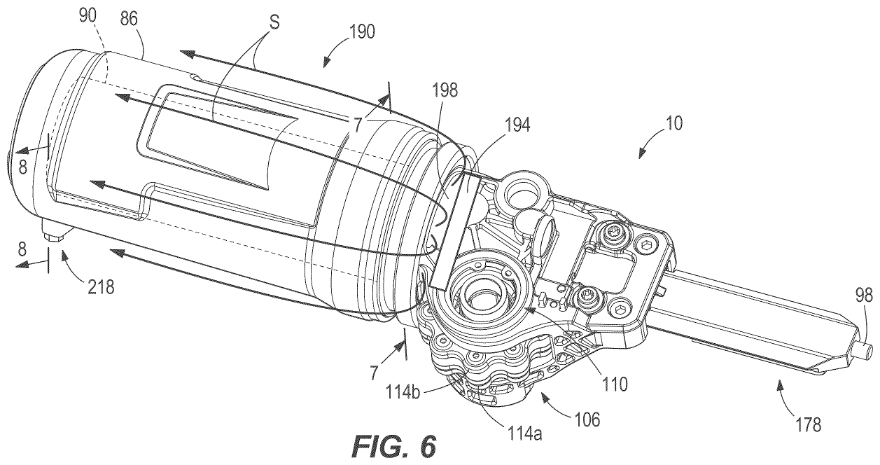

FIG. 6 illustrates an embodiment of a cylinder assembly 190 for use with the fastener driver 10. In the illustrated embodiment, the cylinder assembly 190 includes the inner cylinder 90 (illustrated in FIG. 6 with dashed lines) and the storage chamber cylinder 86. In other embodiments, the cylinder may be comprised of a single, long cylinder. In the embodiment of a single, long cylinder, a storage cylinder is not necessary because the longer cylinder includes additional volume to accommodate the compressed gas that otherwise would be stored in the storage cylinder. In other embodiments, the cylinder includes a single cylinder and a storage compartment such that compressed gas may be accommodated in the storage compartment because the single cylinder does not have available volume to store the compressed gas. For instance, the storage compartment may be an additional tank that is fluidly connected to the single cylinder. In combination with the cylinder assembly 190, the fastener driver 10 includes a baffle 194 adjacent an opening 198 in a bottom wall of the cylinder assembly 190. The opening 198 provides clearance for the driver blade 98 as the piston 94 and the driver blade 98 are driven between the TDC position and the BDC position. As the piston 94 is driven from BDC position to TDC position, ambient air from the interior of the fastener driver is pulled into the cylinder assembly 190. When released from the TDC position, the compressed gas above the piston 94 drives it and the driver blade 98 toward the BDC position. As the piston 94 is driven toward the BDC position, the air within the cylinder assembly 190 and below the piston 94 is expelled out of the cylinder assembly 190 via the opening 198. The expelled air impacts the baffle 194 and is redirected by the baffle 194 as an expelled airflow S. A first portion of the airflow S is used for cooling the cylinder assembly 190.

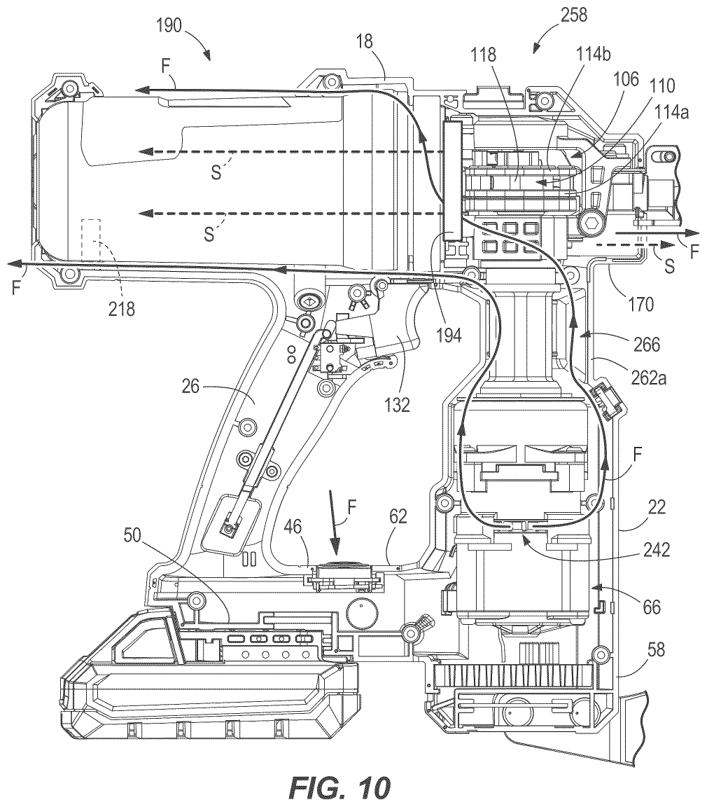

In some embodiments, the baffle 194 is coupled to the cylinder assembly 190. In some embodiments, the baffle 194 is integrated with the cylinder assembly 190. In some embodiments, the baffle is integrated into the cylinder support portion 18. As illustrated in FIG. 6, the baffle 194 is configured to direct the expelled air toward and around the cylinder assembly 190 as the airflow S. The baffle 194 directs the first portion of the airflow S along an entire outer surface of the cylinder assembly 190. The first portion of the airflow S cools the cylinder assembly 190 because the cylinder assembly 190 may increase in temperature due to repeated cycles of the piston 94 traveling between TDC position and BDC position. In other embodiments, the baffle 194 may direct the first portion of the airflow S toward the cylinder assembly 190 and a second portion toward other locations within the fastener driver 10. For example, the baffle 194 could redirect the second portion of the airflow S is toward the outlet opening 170 and/or the lifting assembly 106. The second portion of the airflow S directed toward the outlet opening 170 expels dust and debris from the outlet opening 170 (FIG. 10). In other words, the second portion of the airflow S is directed away from the cylinder assembly 190 to clear and/or prevent debris accumulated in the cylinder support portion (not shown). Additionally, the second portion of the airflow S expels dust and debris from the nosepiece assembly 178.

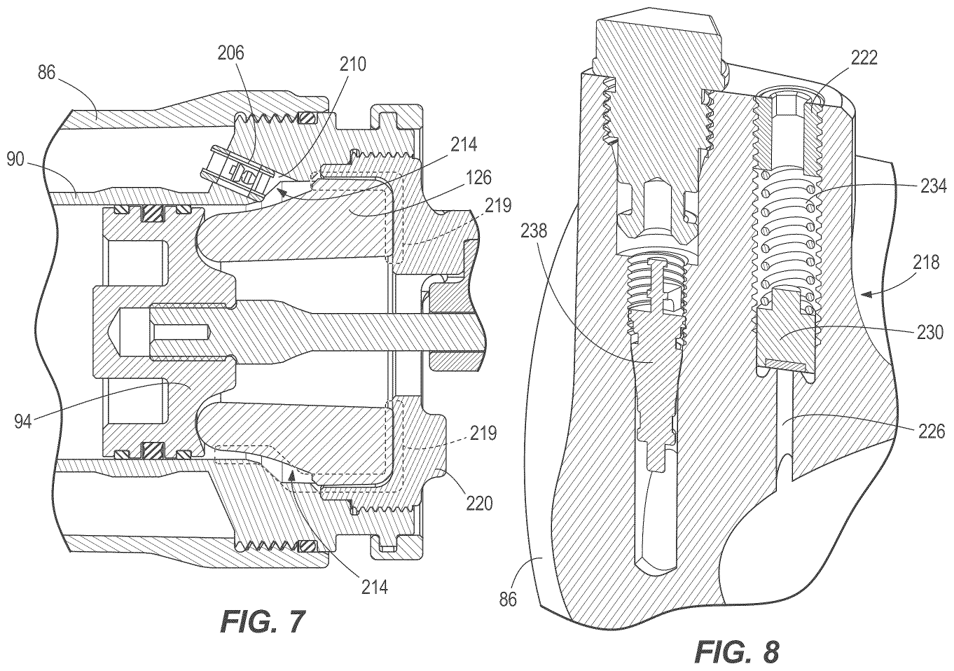

FIG. 7 illustrates the cylinder assembly 190 including an optional check valve 206 positioned between the bumper 126 and the outer storage chamber cylinder 86 within a passageway 210. The check valve 206 is responsive to pressure as the piston 94 compresses the bumper 126. More specifically, as the piston 94 is driven from the ready position to the driven position, the piston 94 impacts the bumper 126, which seals against the inner cylinder 90 to create an air reservoir or annular intermediate chamber 214. The intermediate chamber 214 is formed between a bottom portion of the inner cylinder 90 and the bumper 126 (and in some circumstances, the bumper 126 and the piston 94) when the driver blade 98 approaches the bottom-dead-center position. That is, the intermediate chamber 214 is completely sealed (i.e., not fluidly connected to the outside atmosphere) when the piston 94 impacts the bumper 126. As the piston 94 compresses the bumper 126, a pressure increase occurs in the intermediate chamber 214. The pressure increase in the intermediate chamber 214 opens the check valve 206 to vent pressurized air from the intermediate chamber 214 to the outer storage chamber cylinder 86. This increased air pressure through the opened check valve 206 adds a small amount of pressurized air to the outer storage chamber cylinder 86, which results in a higher pressure applied to the cylinder assembly 190 that can compensate for potential or actual air pressure losses in the fastener driver 10. As such, an increase in air pressure can be generated using bumper compression that occurs at the end of every firing event of the fastener driver 10. This avoids the need for a separate compressor to be attached to the cylinder 86 for increasing the pressure on the piston 94. In effect, the complementary compression of the bumper 126 and the opening of the check valve 206 forms an onboard air compressor for the fastener driver 10.

By using the repetitive compression of the bumper 126 by the piston 94 to complement the pressure in the storage chamber cylinder 86, a small amount of air pressure (e.g., approximately 0.01-0.015 psi) can be added each time the bumper 126 is compressed by the piston 94. Extrapolating this over 1000 nails fired by the driver 10, this added pressure equates to approximately 10-15 psi, which is 10-15% of the total tank pressure. While the added pressure is relatively small compared to the total tank pressure, the added pressure facilitated by compression of the bumper 126 and the opened check valve 206 is enough to maintain an adequate tank pressure even after pressure losses are accounted for (e.g., due to permeation, minor debris ingress, or mild mechanical wear).

In some circumstances, operational temperature associated with the fastener driver 10 or ambient temperature, or both, may increase the pressure applied to the piston 94 to an extent that a pressure relief is desirable. In these circumstances, and with reference to FIG. 8, the fastener driver 10 can include a pressure relief valve 218 that opens at a predetermined pressure to vent air when the pressure in the storage chamber cylinder 86 is higher than the pressure needed to correctly seat the fastener while also avoiding having the fastener driver 10 absorb more energy from movement of the piston 94 than is necessary. For example, at high temperatures, the pressure on the piston 94 may increase to an extent where air is vented via the pressure relief valve 218 to keep the fastener driver 10 within a desired pressure tolerance range. In addition, in low operating temperatures for the fastener driver 10, the onboard compressor defined by the compression of the bumper 126 and opening of the check valve 206 (i.e., leveraging the air reservoir formed by the bumper 126 when the bumper 126 seals against the inner cylinder 90) assists with repressurizing the cylinder assembly 190 to maintain performance of the fastener driver 10.

In some embodiments, the fastener driver 10 optionally includes a thermal conductor 219 (e.g., a thermal paste or a thermal grease) disposed between the bumper 126 and the cylinder 90 (e.g., the inner cylinder). In some embodiments, the thermal paste 219 is comprised of boron nitride. In some embodiments, the thermal paste 219 is comprised of graphite. In some embodiments, the thermal paste 219 is silicon-based. In the illustrated embodiment, the thermal conductor 219 fills the annular intermediate chamber 214 to increase the thermal conductivity between the bumper 126 and the inner cylinder 90. In some embodiments, the thermal paste 219 is applied in the annular intermediate chamber 214 but permits fluid communication to the check valve 206. In other words, some of the annular intermediate chamber 214 may remain unfilled with the thermal paste 219 to provide unobstructed access to the check valve 206. By using a thermal conductor 219, such as a thermal paste, between the bumper 126 and the cylinder 90, heat transfer from the bumper 126 to the cylinder 90 can be increased.

In the illustrated embodiment of FIG. 7, the fastener driver 10 includes a frame 220. The frame 220 is coupled to the inner cylinder 90 and the inner cylinder 90 is coupled to the outer storage chamber cylinder 86. In the illustrated embodiment, the thermal conductor 219 is disposed between the bumper 126 and the frame 220. As such, the thermal conductor 219 increases the thermal conductivity between the bumper 126 and the frame 220, thereby increasing the heat transfer therebetween. The thermal conductor 219 increases the heat transferred from the bumper 126 to surrounding components (e.g., the cylinder 90 and the frame 220). The increased heat transfer between the bumper 126 and surrounding components results in a lower temperature of the bumper 126, which can increase the useful life of the bumper 126.

It will be appreciated that some embodiments of the fastener driver 10 may include, in combination, the check valve 206 to increase pressure within the storage chamber cylinder 86 and a pressure relief valve 218 that relieves pressure from the storage chamber cylinder 86.

With reference to FIG. 8, the pressure relief valve 218 includes a seat 222 disposed in a passageway 226 of the storage chamber cylinder 86, a pin 230 disposed in the passageway 226, and a spring 234 positioned between the seat 222 and the pin 230 to bias the pin 230 toward the storage chamber cylinder 86 to seal the passageway 226. The seat 222 is coupled to the passageway 226 via threads in the passageway 226. The seat 222 is visible externally from the fastener driver 10. The seat 222 fluidly communicated with an interior of the cylinder assembly 190 with ambient surroundings of the fastener driver 10. The pin 230 is slidable in the passageway 226 between a closed position and an open position. The pin 230 is moveable from the closed position to the open position when the pressure of the pressurized air within the storage chamber cylinder 86 exceeds the predetermined value. In the closed position, the pressure of the pressurized air is at or below the predetermined value, allowing the spring 234 to bias the pin 230 away from the seat 222. In the open position, the pressure of the pressurized air within the storage chamber cylinder 86 is above the predetermined value, such that the pressurized air biases the pin 230 toward the seat 222, against the bias of the spring 234. In some embodiments, a refill valve 238 may be disposed proximate the pressure relief valve 218. The refill valve 238 allows a user to add pressurized air to the storage chamber cylinder 86. In some embodiments, the refill valve 238 is located past the TDC position of the piston 94 such that the piston 94 does pass over an opening of the refill valve 238.

The pressure relief valve 218 opens at a predetermined pressure value to vent air when the pressure in the storage chamber cylinder 86 is higher than the pressure needed to correctly seat the fastener, while also avoiding having the bumper 126 absorb more energy from movement of the piston 94 than is necessary. For example, at high temperatures, the pressure on the piston 94 may increase to an extent where air is vented via the pressure relief valve 218 to keep the fastener driver 10 operating within a desired range of operating pressures. In addition, in low operating temperatures for the fastener driver 10, piston pumping during the second stage assists with repressurizing the cylinder 86 to maintain the fastener driver 10 within a desired range of operating pressures.

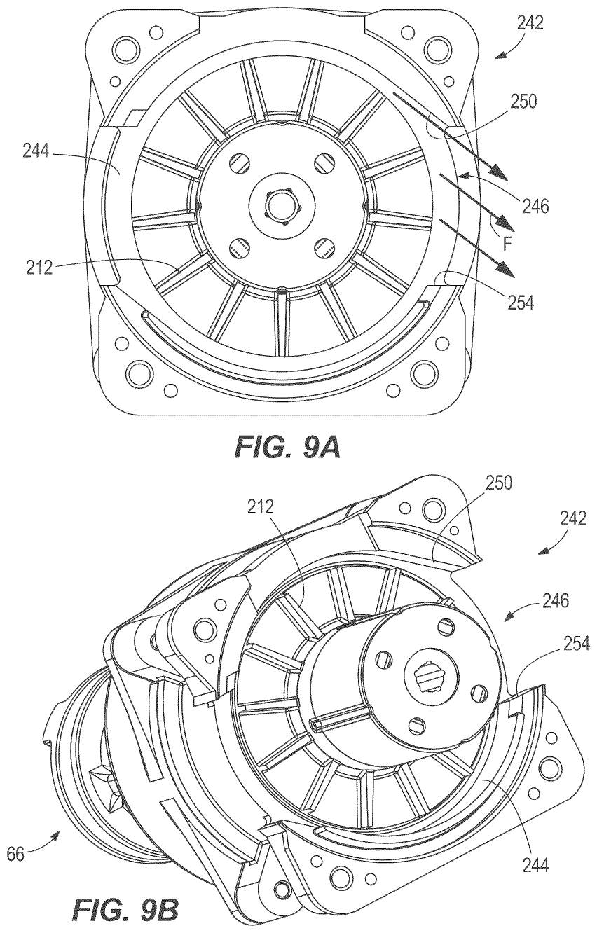

FIGS. 9A and 9B illustrate a fan 242 for use with the fastener driver 10. In contrast to the fan 82, the fan 242 includes a baffle 244 having a tangential opening 246. The baffle 244 surrounds the fan 242. The fan 242 includes straight blades 212 configured to induce the airflow F via rotating clockwise relative to the frame of reference. The tangential opening 246 includes a tangential edge 250 to an outer diameter of the fan 242. The tangential opening 246 also includes a parallel edge 254 to the tangential edge 250. The tangential opening 246 directs the airflow F to exit the motor casing 70 and toward the conduit 130 (FIG. 2). In some embodiments, the airflow F is directed though a conduit integrated with the first and second clamshell halves 30a, 30b and toward the cylinder assembly 190, such as the airflow F shown in FIG. 10.

FIG. 10 illustrates another embodiment of a fastener driver 258 with like features as the fastener driver 10 being identified with like reference numerals. The fastener driver 258 is like the fastener driver 10 and therefore only differences will be discussed. The fastener driver 258 includes the cylinder assembly 190 and the motor fan 242. The fastener driver 258 includes a first clamshell half 262a and a second clamshell half (not shown) that define an interior conduit 266 that routes the airflow F through the motor housing 22, past the lifting assembly 106, and around the cylinder assembly 190. As such, the cylinder assembly 190 is cooled from a combined airflow resulting from the airflow F and the airflow S. In some embodiments, the only air flowing over the cylinder assembly 190 is from airflow F to cool the cylinder assembly 190. In some embodiments, the only air flowing over the cylinder assembly 190 is from the airflow S to cool the cylinder assembly 190. In some embodiments, a portion of the airflow F is used to cool the cylinder assembly 190 and another portion of the airflow F is used to clear dust and debris from the nosepiece assembly (not shown) after exiting the outlet opening 170.

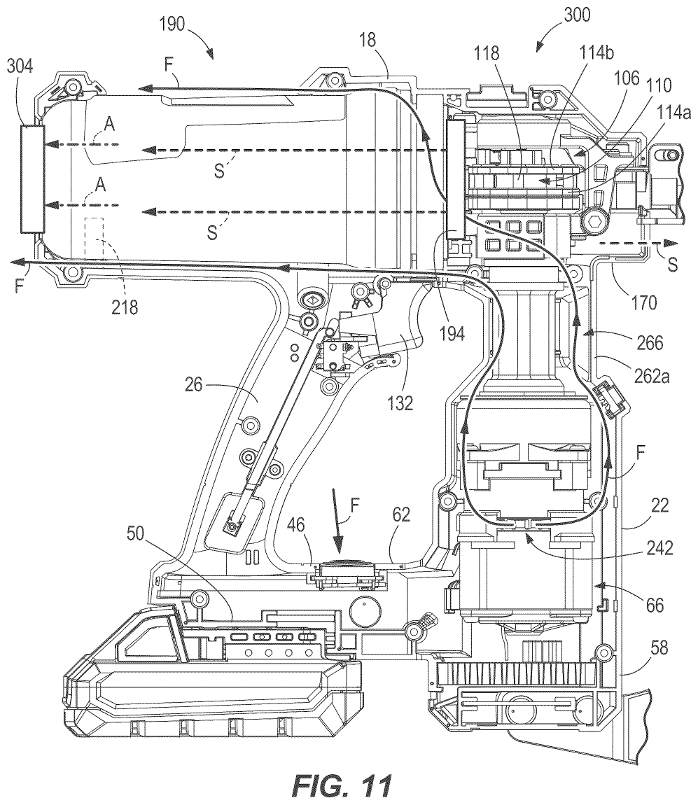

FIG. 11 illustrates another embodiment of a fastener driver 300 with like features as the fastener driver 10 being identified with like reference numerals. The fastener driver 300 is like the fastener driver 10 and therefore only differences will be discussed. The fastener driver 300 includes an auxiliary fan 304 positioned at a rear of the cylinder assembly 190. In some embodiments, the auxiliary fan 304 is supported by the first clamshell half 262a and the second clamshell half. In some embodiments, the auxiliary fan 304 is coupled to the cylinder assembly 190. The auxiliary fan 304 is powered with electric current from the battery pack with wiring (not shown) routed through the motor housing 22 or the handle portion 26. In the illustrated embodiment, the auxiliary fan 304 induces an airflow A (e.g., an auxiliary airflow) that pulls air around the cylinder assembly 190. In other embodiments, the direction of airflow induced by the auxiliary fan 304 may be reversed, such that the auxiliary fan 304 may discharge or “push” air around the cylinder assembly 190. The airflow A cools the cylinder assembly 190.

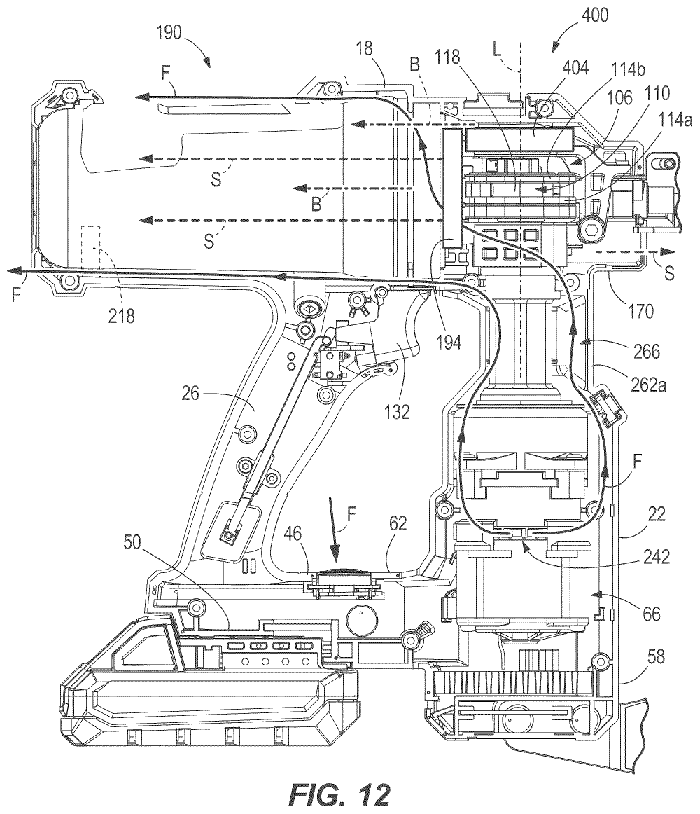

FIG. 12 illustrates another embodiment of a fastener driver 400 with like features as the fastener driver 10 being identified with like reference numerals. The fastener driver 400 is like the fastener driver 10 and therefore only differences will be discussed. The fastener driver 400 includes an auxiliary fan 404 positioned adjacent the lifting assembly 106. The auxiliary fan 404 is coaxial with a lifter axis L defined by the lifting assembly 106 and creates an airflow B transverse to the lifter axis L and around the cylinder assembly 190. In some embodiments, a baffle (not shown) may be positioned around or next to the auxiliary fan 404 to redirect the airflow B around the cylinder assembly 190. The auxiliary fan 404 may either receive torque from the lifting assembly 106 to cause the auxiliary fan 404 to rotate, or, the auxiliary fan 404 may be powered by electrical current like the auxiliary fan 304 described above.

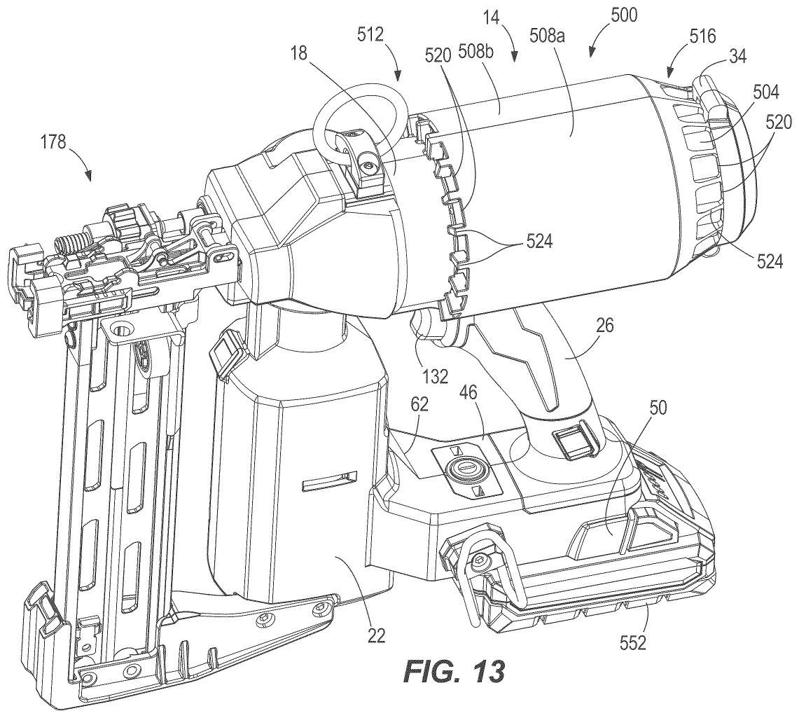

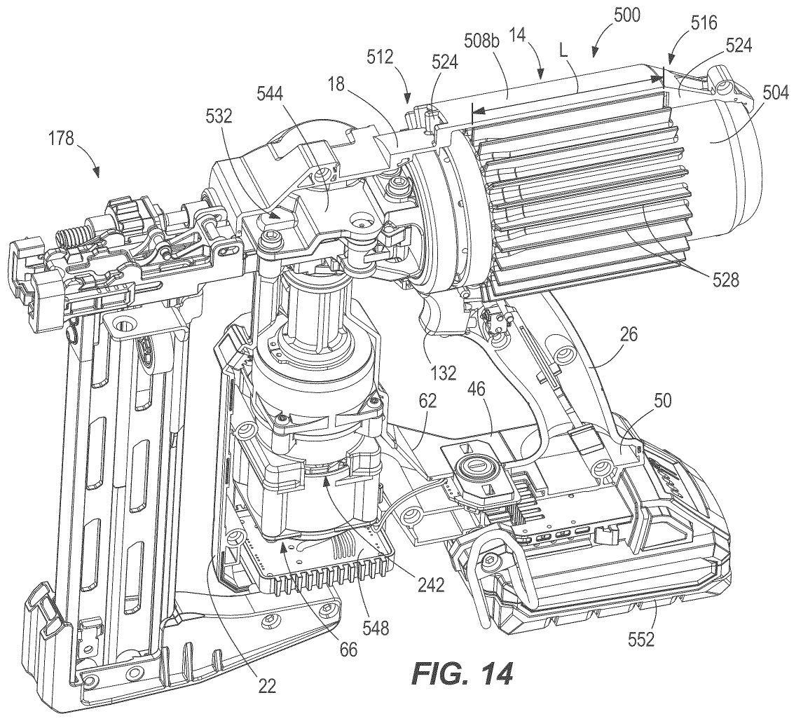

FIG. 13 illustrates another embodiment of a fastener driver 500 with like features as the fastener driver 10 being identified with like reference numerals. The fastener driver 500 is like the fastener driver 10 and therefore only differences will be discussed. The fastener driver 500 includes an outer storage chamber cylinder 504 (FIG. 14) that is supported by the cylinder support portion 18 of a first clamshell half 508a and a second clamshell half 508b. The first and second clamshell halves 508a, 508b include a first vent 512 and second vent 516. The first vent 512 and the second vent 516 include a plurality of openings 520 that are separated by a plurality of vanes 524. The first vent 512 is disposed closer to the nosepiece assembly 178 relative to the second vent 516.

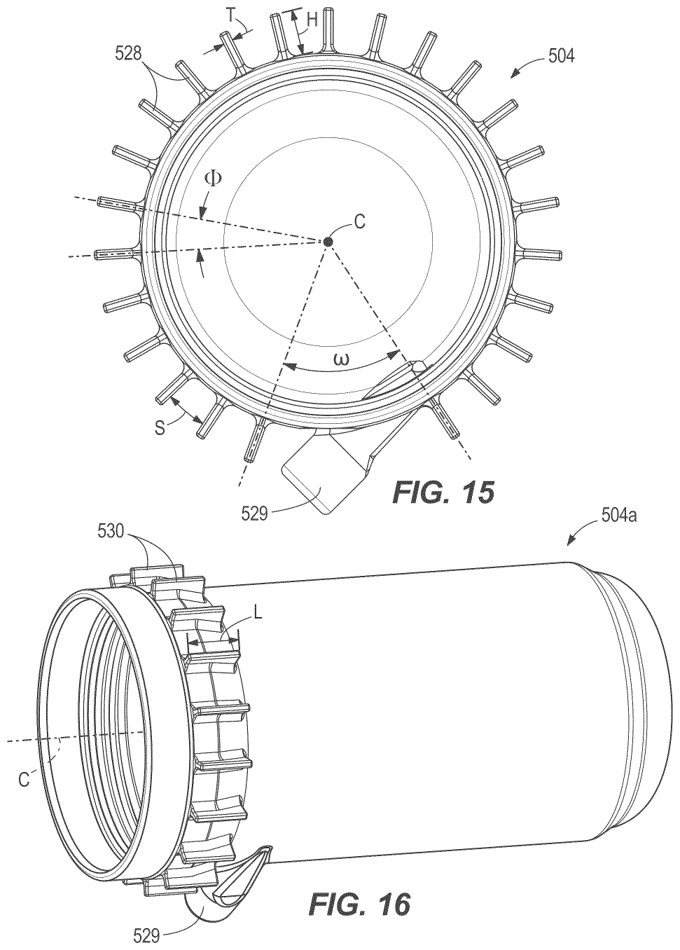

FIG. 14 illustrates the outer storage chamber cylinder 504 including a plurality of fins 528 that extend along an outer surface of the outer storage chamber cylinder 504 parallel to a longitudinal axis C of the outer storage chamber cylinder 504 (FIG. 15). Each of the fins 528 includes a length L. In the illustrated embodiment, the length L is approximately 100 millimeters. In some embodiments, the length L is less than 100 millimeters. In some embodiments, the length L is greater than 100 millimeters. In some embodiments, the fins 528 extend radially outward from an outer surface of the outer storage chamber cylinder 504 relative to the longitudinal axis C of the outer storage chamber cylinder 504. In the illustrated embodiment, the fins 528 are located at an end of the outer storage chamber cylinder 504 where the inner cylinder 90 is connected, since this end of the outer storage chamber cylinder 504 experiences heat transferred from the repeated impacts between the piston 94 and the bumper 126. In some embodiments, the fins 528 extend to an opposite, distal end of the outer storage chamber cylinder 504 to maximize the surface area through which heat transfer may occur. In some embodiments, the fins 528 are disposed on a surface of the inner cylinder 90. The plurality of fins 528 function as a heatsink. The fins 528 are received within the first and second clamshell halves 508a, 508b between the first vent 512 and the second vent 516. The first and second clamshell halves 508a, 508b entirely enclose the fins 528. In some embodiments, the fastener driver 500 optionally incudes the baffle 194 to redirect the airflow S along the outer surface of the outer storage chamber cylinder 504. Specifically, the airflow S will be between the first and second clamshell halves 508a, 508b and the fins 528. In some embodiments, the fastener driver 500 optionally includes the auxiliary fan 304 to induce the airflow A, which results in airflow between the first clamshell half 508a and the fins 528. In some embodiments, heat transfer may occur with the fins 528 via natural convection and, in other embodiments, heat transfer may occur with the fins 528 via forced convection (e.g., using a fan to induce an airflow through and/or across the fins 528).

FIG. 15 illustrates the fins 528 arranged about an outer circumference of the outer storage chamber cylinder 504. In the illustrated embodiment, the fins 528 include a total of 24 fins angularly offset from one another relative to the longitudinal axis C by an angle Φ. In the illustrated embodiment, the angle Φ is 13.5 degrees. In some embodiments, the angle Φ is between 1 degree and 180 degrees. Specifically, in some embodiments, the angle Φ is between 10 degrees and 20 degrees. In some embodiments, the fins 528 includes fewer than 24 fins. In some embodiments, the fins 528 include more than 24 fins. In some embodiments, the fins 528 are unevenly distributed about the longitudinal axis C. In other words, some adjacent fins 528 may not be separated by the same angle Φ. Each of the fins 528 includes a thickness T. In the illustrated embodiment, the thickness T is 2 millimeters. In some embodiments, the thickness T is between 1 millimeter and 25 millimeters. In some embodiments, some of the fins 528 each include a thickness that is different from one another. Each of the fins 528 includes a height H. In the illustrated embodiment, the height H is approximately 10 millimeters. In some embodiments the height is less than 10 millimeters. In some embodiments, the height H is more than 10 millimeters. In the illustrated embodiment, a fill valve 529 interrupts the fins 528. In other words, two of the fins 528 are angularly offset by a larger angle ω so there is space for the fill valve 529. In some embodiments, the fill valve 529 is configured as a Schrader valve. Optionally, the outer storage chamber cylinder 504 may include a pressure relief valve (e.g., pressure relief valve 218) in parallel with the fill valve 529.

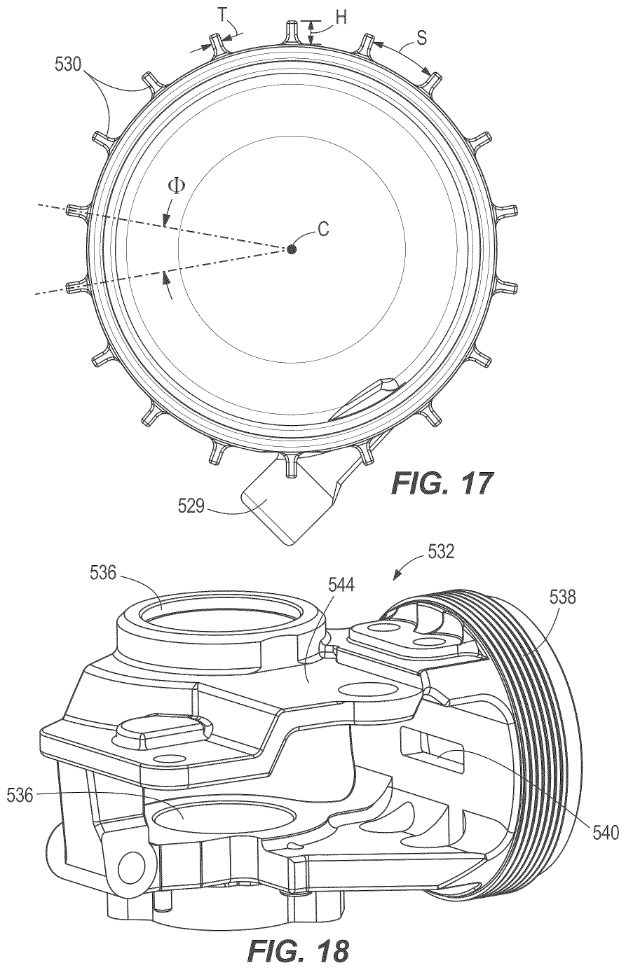

FIGS. 16 and 17 illustrate another outer storage chamber cylinder 504a that is interchangeable with the outer storage chamber cylinder 504. In contrast to the outer storage chamber cylinder 504, the outer storage chamber cylinder 504a includes a plurality of fins 530 that are arranged around an entirety of an outer circumference of the outer storage chamber cylinder 504a. Specifically, the fill valve 529 does not interrupt the fins 530. In other words, the fill valve 529 does not axially overlap with the fins 530 along the axis C. In the illustrated embodiment, the length L of each of the fins 530 is approximately 10 millimeters, the thickness T is 2 millimeters, and the height H is approximately 4 millimeters.

For the fins 528, 530 the length L, the thickness T, and the height H may be adjusted such that a surface area of the fins 504, 530 is increased or decreased depending on the cooling needs of the fastener driver 500. For instance, the fins 530 provide a smaller surface area than the fins 528. A smaller surface area equates to a smaller and a more compact profile of the outer storage chamber cylinder 504. Additionally, spacing S between fins of the fins 528 and 530 may be adjusted depending on the thickness T, the angle D, and total number of fins. The spacing S is significant to the fins 528, 530 because it influences the efficiency of the heat dissipation of the fins 528, 530.

The fastener driver 500 includes a frame 532 that is coupled to the inner cylinder 90 and is configured to support the lifting assembly 106 between parallel flanges 536 extending downward from the cylinder support portion 538 of the frame (FIGS. 14 and 18). The frame is interchangeable with the frame 220 (FIG. 7). The frame 532 is within the first and second clamshell halves 508a, 508b. The frame 532 includes a slot 540 through which the driver blade 98 extends. The fastener driver 500 includes a Peltier chip 544 mounted to the frame 532. In the illustrated embodiment, the Peltier chip 544 is mounted to one of the flanges 536. Since the Peltier chip 544 is mounted to the frame 532, the frame 532 is cooled by the Peltier chip which increases the difference in temperature between the frame 532 and the inner cylinder 90. The difference in temperature promotes heat transfer between the inner cylinder 90 and the frame 532, thereby removing heat from the inner cylinder 90. Heat is also transferred from the outer storage chamber 504 to the inner cylinder 90 and to the frame 532. In other words, the Peltier chip 544 increases the amount of heat conducted by the frame 532 from the cylinders 90, 504. In the illustrated embodiment, the Peltier chip 544 is coupled to a printed circuit board (PCB 548;

FIG. 14), which supplies electrical current to the Peltier chip 544 from a battery pack 552. Additionally, the PCB 548 includes a controller that is programmed to control operation of the Peltier chip 544.

Although the invention has been described in detail with reference to certain preferred embodiments, variations and modifications exist within the scope and spirit of one or more independent aspects of the invention as described.

Various features of the disclosure are set forth in the following claims.

1. A powered fastener driver comprising:
a housing defining a cylinder support portion and a motor housing portion;
a cylinder within the cylinder support portion;
a piston movable within the cylinder from a top-dead-center (TDC) position to a bottom-dead-center (BDC) position;
a driver blade attached to the piston for movement therewith along a driving axis from the TDC position toward the BDC position for driving a fastener into a workpiece;
a lifter operable to move the piston and driver blade, in unison, from the BDC position toward the TDC position;
a nosepiece extending from the housing from which the fastener is discharged;
a motor disposed in the motor housing portion;
a fan coupled to the motor to receive torque therefrom, causing the fan to rotate and generate an airflow; and
a conduit configured to direct the airflow toward at least one of
the nosepiece to clear and/or prevent debris accumulated in the cylinder support portion of the housing, or
the cylinder for cooling the cylinder.

2. The powered fastener driver of claim 1, wherein the conduit is disposed in an interior of the housing.

3. The powered fastener driver of claim 1, wherein the conduit is integrated with the housing.

4. The powered fastener driver of claim 1, wherein the conduit is at least partially defined externally of the housing.

5. The powered fastener driver of claim 4, wherein the conduit includes an inlet defined in the motor housing portion and an outlet defined in the cylinder support portion and in fluid communication with the inlet.

6. The powered fastener driver of claim 1, wherein the cylinder support portion includes a baffle configured to direct the airflow toward the nosepiece.

7. The powered fastener driver of claim 6, wherein the baffle is integrated with the housing.

8. The powered fastener driver of claim 1, wherein the airflow is induced through the motor housing portion to cool the motor.

9. The powered fastener driver of claim 1, wherein the housing further defines a handle portion and a battery receptacle portion, the battery receptacle portion disposed between the handle portion and the motor housing portion, and wherein the battery receptacle portion includes an inlet opening configured to communicate an interior of the motor housing portion and an outside environment.

10. The powered fastener driver of claim 9, further comprising a printed circuit board located in the battery receptacle portion, wherein the airflow is induced through the battery receptacle portion to cool the printed circuit board.

11. The powered fastener driver of claim 1, further comprising a filter upstream of the fan.

12. The powered fastener driver of claim 1, further comprising a baffle extending around the fan to direct the airflow to the conduit.

13. The powered fastener driver of claim 1, further comprising an auxiliary fan.

14. The powered fastener driver of claim 13, wherein the auxiliary fan induces an auxiliary airflow configured to cool the cylinder.

15. The powered fastener driver of claim 13, wherein the auxiliary fan is positioned at a rear of the cylinder.

16. The powered fastener driver of claim 13, wherein the auxiliary fan is positioned adjacent the lifter.

17. The powered fastener driver of claim 1, further comprising a pressure relief valve in fluid communication with the cylinder and configured to open in response to a pressure of pressurized air within the cylinder exceeding a predetermined value.

18. The powered fastener driver of claim 1, wherein the cylinder is an inner cylinder and the powered fastener driver further comprises an outer storage cylinder in which compressed gas is stored, wherein the inner cylinder, at a location above the piston, is in fluid communication with the compressed gas in the outer storage cylinder to apply pressure to the piston when in the TDC position, wherein an annular intermediate chamber is formed between a bottom portion of the inner cylinder and a bumper, wherein a passageway connects the annular intermediate chamber to the outer storage cylinder, and wherein a check valve is positioned in the passageway.

19. The powered fastener driver of claim 18, wherein a pressure increase in the annular intermediate chamber occurs in response to the piston impacting the bumper, and wherein the pressure increase in the annular intermediate chamber opens the check valve to vent pressurized air from the annular intermediate chamber to the outer storage cylinder.

20. The powered fastener driver of claim 1, further comprising
an opening in a bottom of the cylinder, the opening providing clearance for expelling air from the cylinder in response to the piston moving from TDC position to BDC position, and
a baffle configured to redirect at least a first portion of the expelled air around the cylinder for cooling.

21. The powered fastener driver of claim 20, wherein a second portion of the expelled air is directed away from the cylinder to clear and/or prevent debris accumulated in the cylinder support portion of the housing.

22.-40. (canceled)
